(19) United States
(12) Patent Application Publication
(10) Pub. No.: US 2013/0007720 A1
(43) Pub. Date: Jan. 3, 2013

(54) Dynamic Isolated Debugging via Class Instrumentation

(75) Inventors: Jun Jie Cai, Shanghai (CN); Guo Liang Huang, Beijing (CN); Rui Liang, ShangDi (CN); Jing Lv, Shanghai (CN); Qing Hai Meng, ShangDi (CN); Jun Jie Nan, ShangDi (CN); Rui Zhi Xu, Shanghai (CN)

(73) Assignee: INTERNATIONAL BUSINESS MACHINES CORPORATION, Armonk, NY (US)

(21) Appl. No.: 13/531,545

(22) Filed: Jun. 24, 2012

(30) Foreign Application Priority Data
Jun. 30, 2011 (CN) 201110182264.X

(51) Int. Cl. G06F 9/44

(52) U.S. Cl. 717/130

(57) ABSTRACT

The disclosure relates to program debugging. More particularly, the disclosure relates to technology for debugging a program without restarting a virtual machine. Embodiments may provide a program debug method in a virtual machine environment, the program running on the virtual machine, the method comprising receiving a request for debugging a program, instrumenting debug logic code into code to be debugged of the program, and running the program code with the debug logic code instrumented, to debug the program. In embodiments the program can be dynamically debugged without restarting the virtual machine or suspending other program threads running on the virtual machine, and without modifying the virtual machine code itself

### BACKGROUND

The invention relates to program debugging and more particularly to systems, methods and devices for debugging a program without restarting a virtual machine.

A virtual machine refers to a physical machine capable of running a program by a software simulation. Virtual machines are generally divided into two types: System Virtual Machines and Process Virtual Machines. The system virtual machine, which is also identified as a “Hardware Virtual Machine,” refers to a virtual machine for a complete system platform supporting a complete operating system. The process virtual machine, which is also identified as an “Application Virtual Machine,” refers to a normal application running in a host operating system, and supports a single process. The process virtual machine can be simply understood as simulating the function of a Central Processing Unit (CPU). One process virtual machine may simultaneously process a plurality of threads from a plurality of application programs.

In order to debug a certain program running on a process virtual machine, the whole virtual machine is regularly restarted, and switched to a debug mode. And when the debugging ends, the whole virtual machine is restarted and switched to a normal running mode (or product mode). In addition, during debugging, a program with treads that correspond to another program running on the virtual machine will also be suspended. Thus, the debugging of a specific or several programs deployed on a virtual machine severely affects the operation of the whole system.

Two technical solutions address the preceding debugging scenarios. One solution may avoid mode switching the virtual machine by diagnosing the running program by only using logs. These logs may be insufficient because of a lack of information available to be gathered or obtained. A second solution may include running the virtual machine simultaneously in both a debug mode and a normal mode. Here, when necessary to debug a certain program on the virtual machine, the program is directly switched to the debug mode, however, the normal mode is still running as well. This simultaneous operation eliminates the need to restart the whole virtual machine and provides that other programs running on the

Virtual machine will not be affected. The simultaneous operation can consume vast amounts of system resources and may require significant time and effort when a program is not compatible with a virtual machine product specification.

### SUMMARY

Embodiments may provide a method or system for debugging a program on a virtual machine without modifying virtual machine code. Embodiments may also provide a method or system for dynamically debugging a program without restarting a virtual machine or stopping other program threads running on the virtual machine.

Embodiments may include a program debugging method in virtual machine environment, where the program is running on the virtual machine, and the method may comprise receiving a request for debugging a program,; instrumenting debug logic code into code to be debugged of the program, and running the program code with the debug logic code instrumented to debug the program.

Embodiments may also include a program debug system in virtual machine environment, where the program is running on a virtual machine, and the system comprises a debug request receiving means, configured to receive a debug request for debugging the program, an instrumenting means, configured to instrument debug logic code into the code to be debugged of said program, and a debug means, configured to run the program code with the debug logic code instrumented to debug the program.

Embodiments may also include method and system that support or provide for instrumenting debug logic code and running the instrumented code. In embodiments dynamic debugging may occur without restarting the virtual machine and without other program threads suspending on the virtual machine. In certain embodiments a debugging agent may be dynamically deployed to an application of a virtual machine and new classes may be instrumented to initiate debugging of the application.

In embodiments described herein, unless particularly expressed, the “virtual machine” mentioned in the disclosure is preferably a “Process Virtual Machine.”

### BRIEF DESCRIPTION OF THE DRAWINGS

FIG. 1 shows a block diagram of an illustrative computing system 100 as may be employed in embodiments.

FIG. 2A shows a flowchart of a program debug method in a virtual machine environment as may be employed in embodiments.

FIG. 2B shows a code example of a debug agent based on a JVM environment as may be employed in embodiments.

FIG. 2C shows a code example of debug logic code based on a JVM environment, as may be employed in embodiments.

FIG. 3A shows a flowchart of a program debug method in a virtual machine environment as may be employed in embodiments.

FIG. 3B shows a particular code example for removing de-bugging logic code as may be employed in embodiments.

FIG. 4 shows a module block diagram of a program debug system in a virtual machine environment as may be employed in embodiments.

FIG. 5 shows a module block diagram of a program debug system in a virtual machine environment as may be employed in embodiments.

FIG. 6 shows a schematic of a program debug system in a virtual machine environment as may be employed in embodiments.

### DETAILED DESCRIPTION

Methods, systems, and devices for debugging a program in a virtual machine environment are described and explained in the specification and through reference to the drawings identified herein. A plurality of aspects of the invention may be embodied as systems, methods, devices or computer program products. Embodiments can include hardware or code (including firmware, resident code or software, microcode, and so on). A combination of code and hardware may also be used. This combination may be referred to as a “circuit,” “module” or “system.” In addition, the plurality of aspects of the invention can be embodied as a form of computer program product in one or more computer readable mediums wherein the computer readable mediums include program code usable by a computer.

The computer program code for executing operations of the invention can be edited in any combination of one or more program design languages, and the program design language can include object-oriented program design language, such as Java, Smalltalk, C++ and so on. The design languages may also include normal progress program design language, such as “C” design language or similar program design languages. The program code can be executed completely on a computer of the user, executed partly on the computer of the user, executed as an independent software package, executed partly on the computer of the user and partly on a remote computer, or executed completely on the remote computer or a server. In the latter case, the remote computer can be connected to the computer of the user through any kind of network, including local area network (LAN) or wide area network (WAN), or can be connected to an external computer (for example, by using an Internet service provider through the Internet).

The plurality of aspects of the invention are described with reference to the flowchart and/or the block diagram of the method, apparatus (system) and computer program product according to embodiments of the invention. It is to be understood that each block of the flowchart and/or the block diagram, and a combination of respective blocks of the flowchart and/or the block diagram, can be realized by computer program instructions. These computer program instructions can be provided to a general purpose computer, a dedicated computer or other processors of programmable data processing apparatus, so as to produce a machine, so that means for realizing functions/operations defined in the blocks in the flowchart and/or the block diagram are produced by these instructions executed by the computer or other programmable data processing apparatus.

These computer program instructions can be also stored in the computer readable medium capable of instructing the computer or other programmable data processing apparatus to operate in a particular way, so that the instructions stored in the computer readable medium produce a manufacture of an instruction means for realizing functions/operations defined in the blocks in the flowchart and/or the block diagram.

The computer program instructions can be also loaded onto the computer or other programmable data processing apparatus, so that a series of operation steps are executed on the computer or other programmable data processing apparatus to produce a process realized by the computer, so that the instructions executed on the computer or other programmable apparatus provide a process of functions/operations defined in the blocks in the flowchart and/or the block diagram.

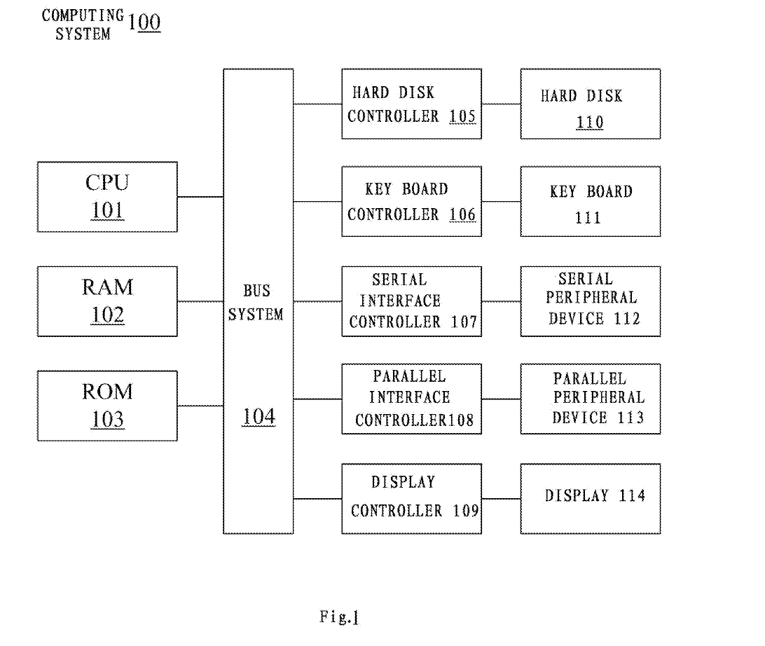

FIG. 1 shows a block diagram of an illustrative computing system 100 adapted to realize an exemplary embodiment of the invention. As shown, the computer system 100 may include a CPU (central processing unit) 101, a RAM (random access memory) 102, a ROM (read only memory) 103, a system bus 104, a hard disk controller 105, a keyboard controller 106, a serial interface controller 107, a parallel interface controller 108, a display controller 109, a hard disk 110, a keyboard 111, a serial external device 112, a parallel external device 113 and a display 114. In these devices, coupled to the system bus 104 are the CPU 101, the RAM 102, the ROM 103, the hard disk controller 105, the keyboard controller 106, the serial controller 107, the parallel controller 108 and the display controller 109. As can be further seen, the hard disk 110 is coupled with the hard disk controller 105, the keyboard 111 is coupled with the keyboard controller 106, the serial external device 112 is coupled with the serial interface controller 107, the parallel external device 113 is coupled with the parallel interface controller 108, and the display 114 is coupled with the display controller 109. It should be understood that the structural block diagram as shown in FIG. 1 is shown only for illustrative purpose, and not for limiting the invention scope. In some cases, some devices can be increased or reduced according to particular conditions.

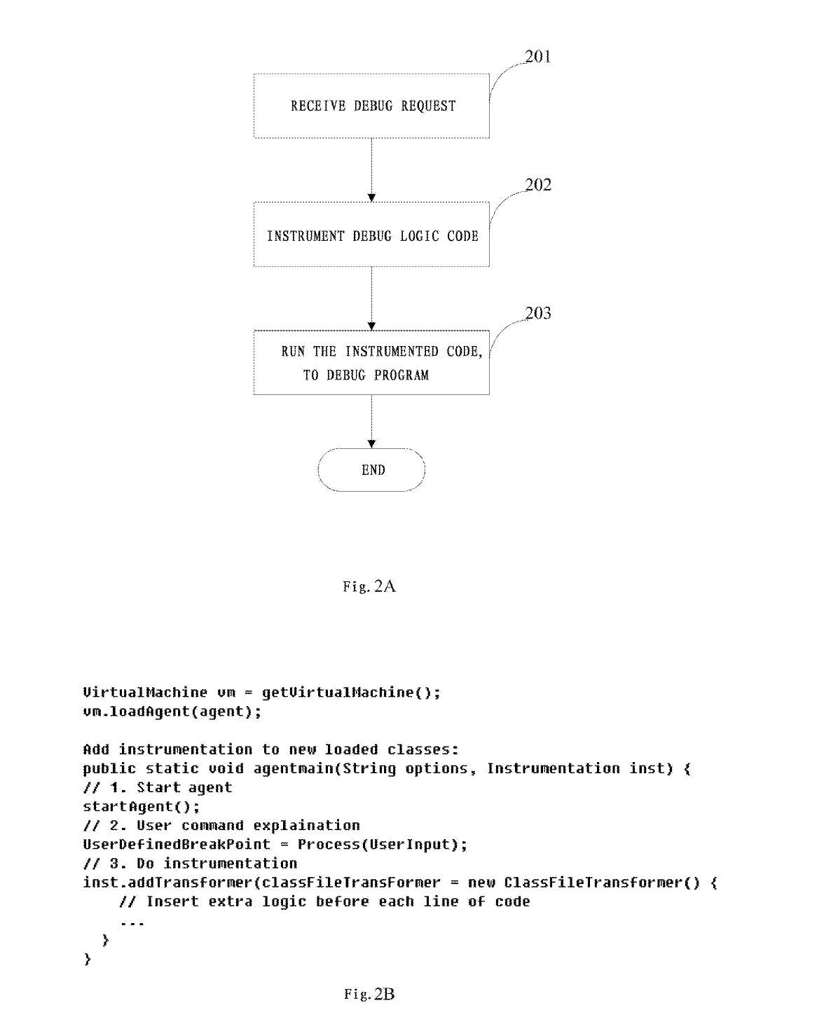

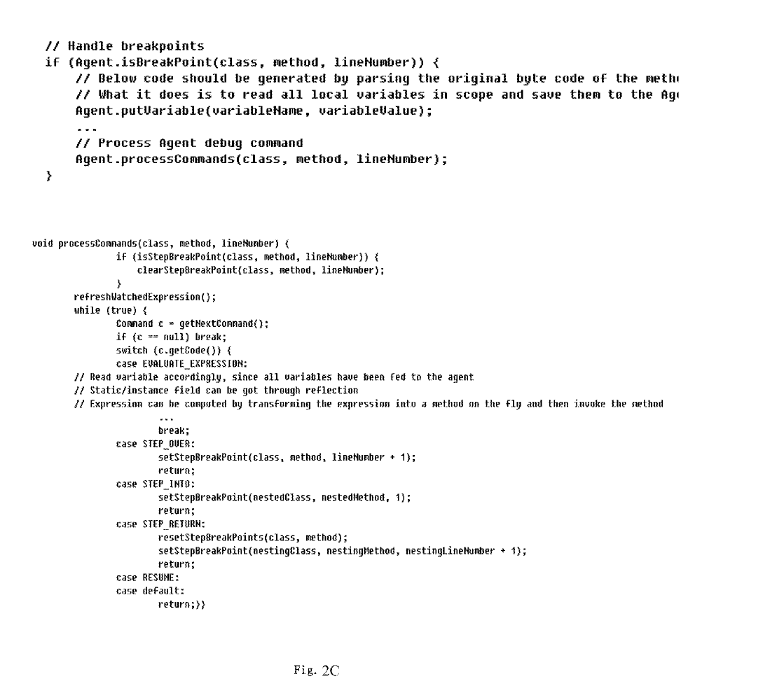

FIG. 2 shows a flowchart of a program debug method in virtual machine environment according to an exemplary embodiment of the invention. The method as shown in FIG. 2 runs under process virtual machine environment, the types of the byte code executed by the process virtual machine can be various, for example, the process virtual machine can execute a program JVM executing Java byte code, and can execute a program of C++ byte code (.NET platform) and other byte code realized based on a script language. The type of the particular byte code executed by the process virtual machine does not influence the realization of the technical concept of the invention, and it is because the instructions executed by the process virtual machine are all in “interpreted language,” and the program in interpreted language may not need to be compiled, but may need to be translated when running the program. That is, the “interpretation” is to translate line-by-line (the person skilled in the art should understand the concepts and the difference of and between the “interpreted language” and the “compiled language”). As explained above, the traditional virtual machine environment executing the “interpreted language” has to restart the virtual machine to switch to a debug mode of the virtual machine when debugging the program, and then needs to suspend the running of other program threads on this virtual machine to perform failure debugging. According to embodiments there may be one or more application programs running on the same virtual machine. The method as shown in FIG. 2 is introduced below in detail.

The method as shown in FIG. 2 may start from step 201. In the step 201 a request for debugging a program running on a virtual machine may be received. According to one embodiment of the invention, the request may be proposed by a “debug” button of the user interface. Since there may be a plurality of program threads running on the same virtual machine, according to embodiments of the invention, a certain program needs to be selected to debug. According to another embodiment of the invention, said debug request refers to the request for debugging one or more classes in a certain program.

Next, the method as shown in FIG. 2 proceeds to step 202 to instrument the code to be debugged of the program, into the debug logic code. Program developers or maintainers may preferably set breakpoints and debug commands, for debugging programs. Taking Java virtual machine JVM as an example, common debug commands include, but are not limited to STEP OVER, STEP INTO, STEP RETURN, NEXT STEP and so on, and the program debug process may preferably be a corresponding operation executed according to the set debug commands, for example, obtaining variables, parameter values and so on. The content of the debug logic code is an operation for defining what to perform based on different debug commands.

According to exemplary embodiments of the invention, the debug logic code may be instrumented before the code lines to be debugged of the program (before the code lines refers to at the beginning of the code lines). This is because according to the definition of the breakpoint, the program should be suspended first before being executed, to facilitate obtaining the context and the variable values. According to another embodiment of the invention, the debug logic code may be instrumented after the code lines to be debugged of the program (after the code lines refer to at the end of the code lines). This is because the person skilled in the art can completely use a way of switching when executing code to instrument the debug logic code into the code lines, as long as it is guaranteed that the instrumented debug logic code is executed first, and then the original code lines are executed. According to an exemplary embodiment of the invention, considering that each line in the program code may possibly have breakpoints, and in order to reduce the likelihood that no breakpoint is missed, preferably, the instrumenting operation is performed on each line of the program.

According to another embodiment of the invention, considering that some lines in the program code do not have practical meaning (for example, are only symbol information such as parentheses and so on), the instrumenting operation may be selectively performed on part of the program code lines (for example, effective code lines). The person skilled in the art should understand that the particular expression of the instrumented debug logic code in the step 202 may preferably be influenced by the particular language of the virtual machine, and may have various forms. The instrumented debug logic code may define what operation to perform based on different debug commands.

According to embodiments, the debug logic code may be instrumented at the corresponding position of the code undergoing its corresponding compiling, line by line, according to the line number in the source code of the program to be debugged. FIG. 2C shows an example of debug logic code based on Java virtual machine environment.

With regard to how to particularly instrument the debug logic code, there may be a plurality of embodiments. According to exemplary embodiments, the debug logic code may be instrumented into the code lines to be debugged of the program by adding a debug agent to said virtual machine, and by class-transforming the program to be debugged through the added debug agent. Herein, the function of the “agent” is to expose some operations of the virtual machine to the user of the virtual machine, and the “agent” can be simply understood as a piece of tag-on program loaded onto the virtual machine. Different virtual machines all provide different “agent” functions, although their implementations may be different, this will not influence the realization of the invention technical concept. According to this embodiment, the “agent” function provided by the virtual machine may be used to instrument the debug logic code into the program code lines to be debugged, i.e., “debug agent”. Taking Java virtual machine JVM as an example, its “agent” is based on the JDWP (Java Debug Wire Protocol Transport Interface) of the JVMTI specification. FIG. 2B gives a code example of a debug agent added to the virtual machine based on the JVM environment of the Java virtual machine.

As to the so-called “Class retransforming” means, after loading the classes of a program, the loaded classes may be rewritten according to the debug logic code. And it is to be noted that, in embodiments, the “agent” can be activated immediately when the virtual machine is started up, or the “agent” can be dynamically loaded after the virtual machine is started up.

According to another embodiment of the invention, instrumenting the debug logic code into the code lines of the program to be debugged may be realized by adding a debug agent to the virtual machine, and class-redefining the program to be debugged through the added debug agent. The difference from the above embodiment lies in that the “class-redefining” means loading classes according to the debug logic code during the process for loading the classes, without waiting until all the classes are loaded, to rewrite them. The similarity to the above embodiment lies in that, based on the embodiment, similarly, the “agent” can be activated immediately when the virtual machine is started up, or the “agent” can be dynamically loaded after the virtual machine is started up.

According to embodiments, instrumenting the debug logic code into the code lines of the program to be debugged is realized by a rewriting class loader. And according to a further embodiment, instrumenting the debug logic code into the code lines of the program to be debugged may be realized by class-transforming the program to be debugged through a compiler. The embodiment actually rewrites the classes according to the debug logic code before starting up the program, and writes it into a hard disk, so as to directly load the rewritten classes from the hard disk after the program is started up.

The person skilled in the art should understand, although the above description only gives out examples of the embodiment of the code based on JVM (the debug agent and the debug logic code), other various “agent” specifications of the virtual machine all belong to the common knowledge of the person skilled in the art, and can be obtained from various disclosed sources. The person skilled in the art can realize the concept of the invention based on different virtual machine implementation environments after understanding the technical concept of the invention.

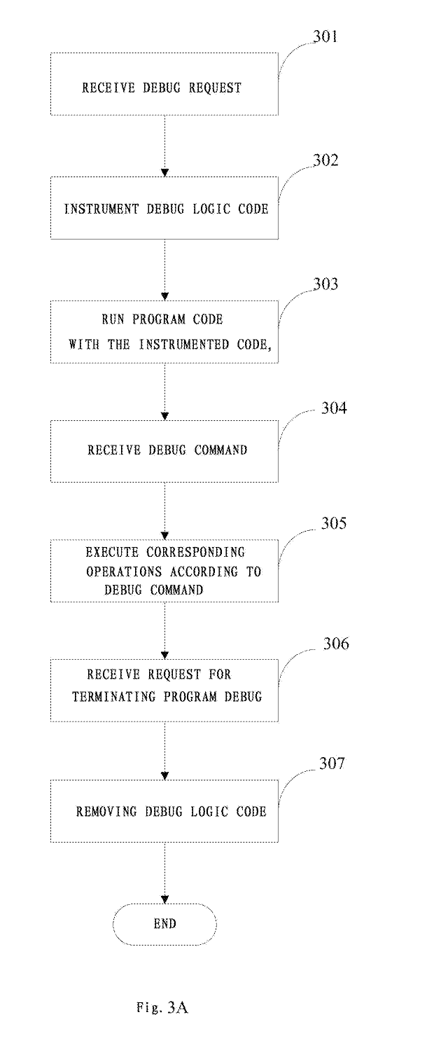

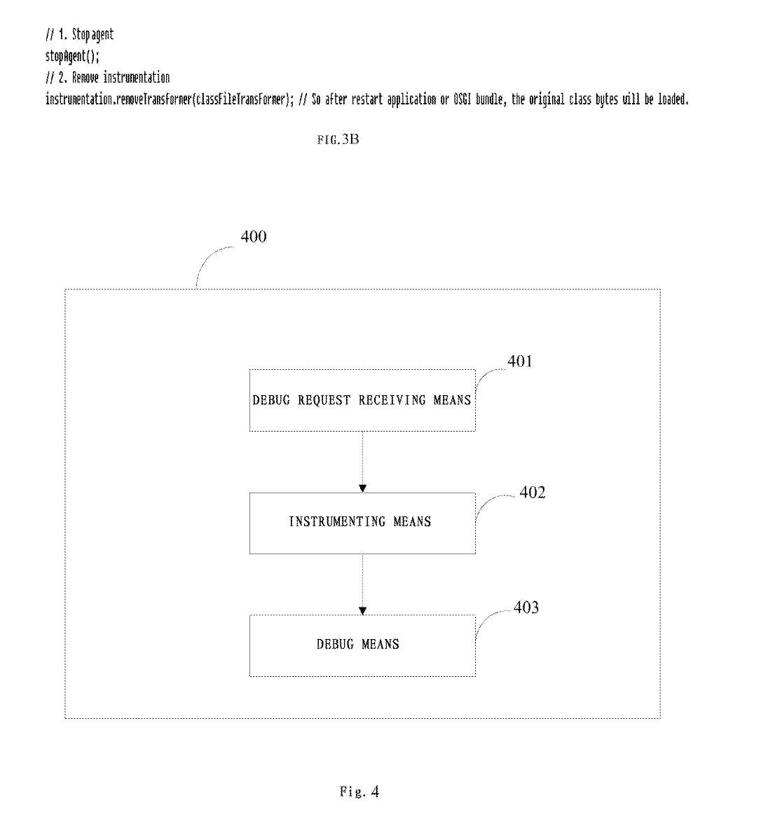

Next, at step 203, the program code with the debug logic code instrumented, are run to debug the program. From the step 203, the particular program debug process will be described in detail in FIG. 3 and its corresponding text description.

It can be seen from the above, since at the step 202 the debug logic code can be dynamically instrumented into the program during the program is run (while in the prior art, the debug logic usually has to be switched to the debug mode of the virtual machine to be executed), the debug operation can be dynamically performed on the program, without stopping other programs running on the virtual machine and restarting the virtual machine to switch it to the debug mode.

FIG. 3 shows a flowchart of a program debug method in a virtual machine environment according to embodiments. In FIG. 3, steps 301 and 302 correspond to the steps 201 and 202 in FIG. 2 respectively, which are not described here. Steps 303, 304 and 305 in FIG. 3 correspond to the step 203 in FIG. 2.

At the step 303, the program code with the debug logic code instrumented, is run line-by-line. At the step 304, the debug command of the program code of the run line (such as Step In under JVM environment) is received. Next, at the step 305, according to the received debug command, the corresponding operation (such as the corresponding operations of various debug commands such as Step Over, step Into, Step Return and so on, as show in the code example of FIG. 2C) defined by the instrumented debug logic code is executed. According to an embodiment of the invention, the received debug command may be sent by the client terminal which issued the debug request.

It is to be noted that, describing the steps 303 to 305, may be only for rendering the operations of the entire debug program more completely, and the person skilled in the art can complete subsequent operations after the program debug according to the debug methods in the prior art and according to particular virtual machine environment, after instrumenting the debug logic code into the code lines of the program to be debugged. Actually, all the operations of the actual program debug may further contain many complex steps. Taking JVM as an example, before running Java code line instruction of each line, it may be necessary to record information of the current line (such as line number), check the current environment variable for debugging and if it is at breakpoint state, stop the running and notify information such as the current line number, the thread, variable names and variable values needed by the user to the client. If the user needs more internal variables, they may be obtained through the function of the virtual machine, which keeps running until receiving the signal from the user. The person skilled in the art should understand, the particular debug operations after instrumenting the debug logic code do not limit the invention, and they may vary depending on different virtual machine environment, and different virtual machine setting, and can realize the concept of the invention, as long as the debug logic code is instrumented and corresponding operations specified by the debug logic code is executed according to the debug command, which falls into the protection scope of the invention.

Next, the method as shown in FIG. 3 proceeds to step 306. At the step 306, a request for terminating the program debug is received, and at step 307, the instrumented debug logic code is removed from the program code. Removing the debug logic code is for recovering normal running of the program and terminating the debug operation. According to many particular embodiments for “instrumenting” the debug logic code as mentioned above, accordingly, after the debug is terminated, methods for removing the debug logic code may be various. Taking the embodiment for realizing “instrumention” by adding the debug agent into the virtual machine and class-transforming the program to be debugged as an example, the instrumented debug logic code can be removed by releasing the added debug agent and releasing the class-transformation.

Refer to the code example in FIG. 3B, steps 306 and 307, even if the debug logic code is not removed or the debug logic code is removed by any other methods, it may not influence the technical effect of the invention or the realization of the object, because once the debug logic code is instrumented and the instrumented program code is run, the program can be dynamically debugged without restarting the virtual machine or suspending other program threads.

FIG. 4 shows a block diagram of a program debug system under a virtual machine environment according to an embodiment of the invention. The system as shown in FIG. 4 is represented by a system 400. The system 400 includes a debug request receiving means 401, configured to receive a debug request for debugging a program; an instrumenting means 402, configured to instrument debug logic code into code to be debugged of said program; and a debug means 403, configured to run the program code with the debug logic code instrumented, to debug the program. The means 401-403 in the system 400 correspond to the steps 201-203 in the method shown in FIG. 2.

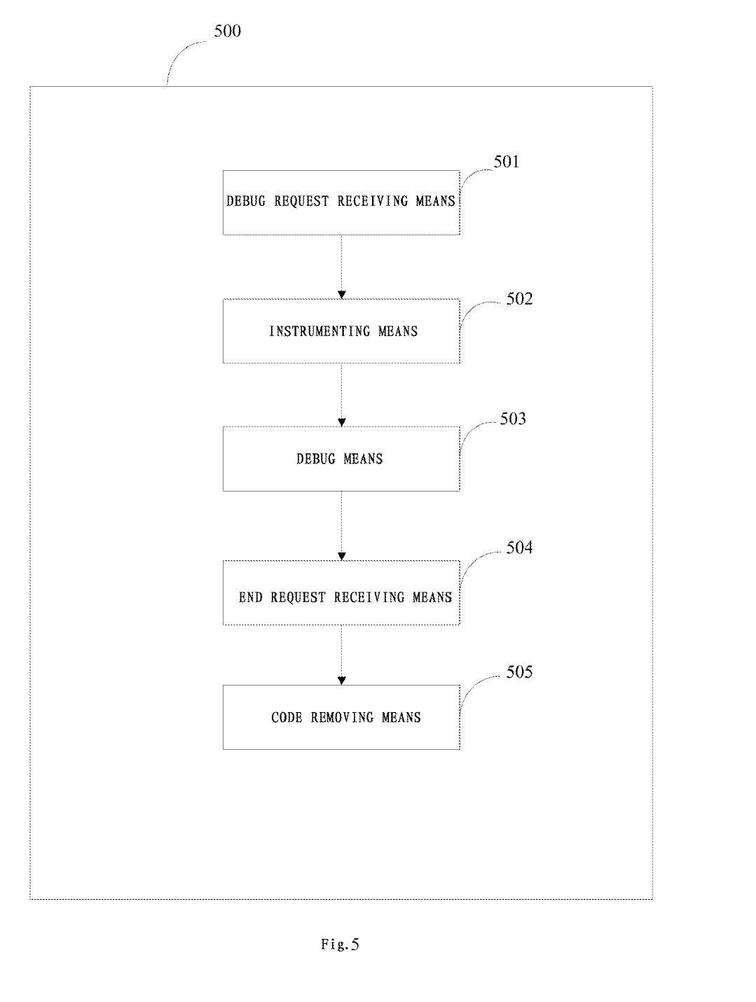

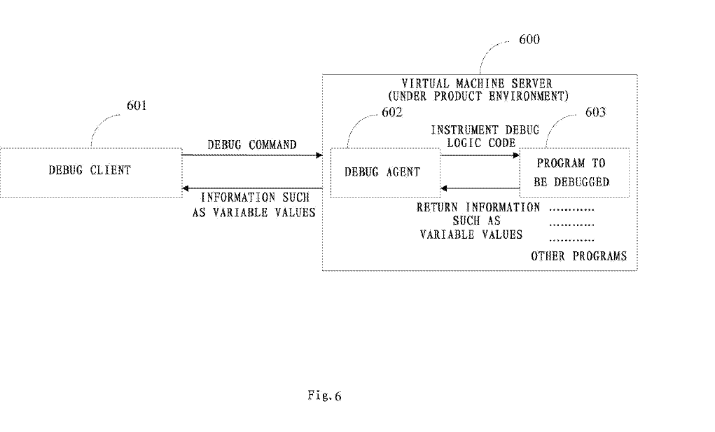

FIG. 5 shows a module block diagram of a program debug system in virtual machine environment according to embodiments. The system as shown in FIG. 5 is represented by a system 500 as a whole. The system 500 includes: a debug request receiving means 501, configured to receive a debug request for debugging a program; an instrumenting means 502, configured to instrument debug logic code into code to be debugged of said program; a debug means 503, configured to run the program code with the debug logic code instrumented, to debug the program; an end request receiving means 504, configured to receive a request for ending the program debugging; a code removing means 505, configured to remove said debug logic code from said program code.

It can be understood that the means 501-503 in the system 500 correspond to the steps 201-203 in the method shown in FIG. 2; the means 503 further corresponds to the steps 303-305 in the method shown in FIG. 3, and the means 504-505 correspond to the steps 306-307 in the method shown in FIG. 3.

FIG. 6 shows an outline diagram of a program debug system in a virtual machine environment according to an embodiment of the invention. The figure label 600 in FIG. 6 represents a virtual machine server (that is, the virtual machine mentioned above), on which many programs run, and one of the programs is the program 603 to be debugged. 601 is a debug client, i.e., the user issuing the debug request and the debug command. 602 is a debug agent added to the virtual machine according to embodiments (as explained above, the debug agent is not necessary, and there are many embodiments for instrumenting the debug logic code). The arrow from 602 to 603 represents that the debug agent instrument the debug logic code into the program to be debugged, and the arrow from 603 to 602 represents that the program to be debugged returns information such as variable values to the debug agent. The arrow from 600 to 601 represents that in response to the debug command from the client, the virtual machine returns information such as variable values needed by the debugging, by executing the program code with the debug logic code instrumented. The person skilled in the art should understand, FIG. 6 is only an overview block diagram of one embodiment of the invention, an instrumentation manner in a macroscopical manner, and it is only for visually showing the inventive concept of the invention, and not to limit the application scope and field of the invention. It can be seen from the block diagram shown in FIG. 6, the virtual machine server 600 may run under product environment (non-debug mode), and since the debug logic code is instrumented into the code lines in the program to be debugged, the client can dynamically debug the program, without switching the virtual machine into a debug mode, and other programs running on the virtual machine server 600 can continue running without any affect, and without restarting the virtual machine server 600.

The flowcharts and the block diagrams in the drawings illustrate the possible architecture, the functions and the operations of the system, the method and the computer program product according the embodiments of the invention. In this regard, each block in the flowcharts or block diagrams may represent a portion of a module, a program segment or a code, and said portion of the module, the program segment or the code includes one or more executable instructions for implementing the defined logical functions. It should be also noted that in some implementations as alternatives, the functions labeled in the blocks may occur in an order different from the order labeled in the drawings. For example, two sequentially shown blocks may be substantially executed in parallel in fact, and they sometimes may also be executed in a reverse order, which is defined by the referred functions. It also should be also noted that, each block in the flowcharts and/or the block diagrams and the combination of the blocks in the flowcharts and/or the block diagrams may be implemented by a dedicated system based on hardware for executing the defined functions or operations, or may be implemented by a combination of the dedicated hardwares and computer instructions.

Any combination of the one or more computer readable mediums can be used. The computer readable mediums can be computer readable signal mediums or computer readable storage mediums. The computer readable storage mediums can be, for example, but not limited to electric, magnetic, optical, electromagnetic, infrared, or semiconductor systems, apparatuses, devices or a combination of any above. The particular examples (not exhaustive list) of the computer readable storage mediums include the following: electrically connecting, with one or more leads, portable computer magnetic disk, hard disk, random access memory (RAM), read only memory, electrically programmable readable read only memory (EPROM) or flash memory, fiber, portable compact disk-read only memory, optical storage device, magnetic storage device, or a suitable combination of any above. In the context of the file, the computer readable storage medium can be any tangible medium containing or storing a program, and the program is used by the system, the apparatus or the device executing the instructions or used with combination with this.

The computer readable signal medium can include data signals propagated in a baseband or as a portion of a carrier, in which the computer readable program code is embodied. The propagated signal can utilize a plurality of forms, including, but not limited to electrical magnetic signal, optical signal or a suitable combination of any above. The computer readable signal medium may not be a computer readable storage medium, but may be any computer readable medium capable of sending, propagating or transmitting a program to be used by a system, an apparatus or a device executing instructions or to be used in combination with them. The program code included in the computer readable medium may use any suitable medium, including, but not limited to wireless, wired, fiber, RF and so on, or a suitable combination of any above to transmit.

The program code included in the computer readable medium may use any suitable medium, including, but not limited to wireless, wired, fiber, RF and so on, or a suitable combination of any above to transmit.

Although the system and the method of processing local files by using a remote-distance application of the invention are described with reference to the preferred embodiments of the invention, the invention is not limited to this. It will be obvious by the person skilled in the art that without departing the spirit and scope of the invention defined by the appended claims, various variation, alternations and modification can be performed on the invention. It should be understood that, all of such variation, alternations and modification still fall within the protection scope of the invention, and the protection scope of the invention is defined by the appended claims.

What is claimed is:

1. A method for program debugging in a virtual machine environment, the program running on the virtual machine, the method comprising:
receiving a request for debugging a program;
instrumenting debug logic code into code to be debugged of the program; and
running the program code with the instrumented debug logic codeinstrument to debug the program,
wherein instrumenting the debug logic code for the program to be debugged is realized by adding a debug agent to the virtual machine, and
class-transforming the program to be debugged through the added debug agent or
class-redefining the program to be debugged through the added debug agent or
class-transforming the program to be debugged through a compiler.

2. The method according to claim 1 wherein the debug logic code includes corresponding operations executed with respect to different debug commands.

3. The method according to claim 2 wherein running the program code with the debug logic code instrumented to debug the program includes:
running the program code with the debug logic code instrumented, line by line;
receiving the debug command of the program code of the line; and
according to the received debug command, executing the corresponding operation defined by the instrumented debug logic code.

4. The method according to claim 1 further comprising:
receiving a request for ending the program debugging; and
removing the debug logic code from said program code.

5. The method according to claim 1 wherein instrumenting the debug logic code before the code lines of the program to be debugged is realized by rewriting a class loader.

6. The method according to claim 1 wherein the request for debugging the program includes a request for debugging a part of classes in the program, and wherein the code lines of the program to be debugged include code lines of a part of classes to be debugged.

7. The method according to claim 1 wherein the virtual machine is a process virtual machine.

8. The method according to claim 1 wherein instrumenting the debug logic code before the code lines of the program to be debugged includes:
instrumenting the debug logic code before the code lines to be debugged of the program.

9. A program debug system in a virtual machine environment, the program running on a virtual machine, the system comprising:
a debug request receiving means for receiving a debug request for debugging a program;
an instrumenting means for instrumenting debug logic code into code to be debugged of the program; and
a debug means for running the program code with the debug logic code instrumented, to debug the program.

10. The system according to claim 9 wherein the debug logic code includes corresponding operations executed with respect to different debug commands.

11. The system according to claim 9, wherein running the program code with the debug logic code instrumented to debug the program includes:
running the program code with the debug logic code instrumented line by line;
receiving the debug command of the program code of the line; and
according to the received debug command, executing the corresponding operation defined by the instrumented debug logic code.

12. The system according to claim 9 further comprising:
an end request receiving means for receiving a request for ending the program debugging; and
a code removing means for removing the debug logic code from the program code.

13. The system according to claim 9, wherein, the instrumenting means is configured to add a debug agent to the virtual machine and to class-transform the program to be debugged through the added debug agent, to realize instrumenting the debug logic code before the code lines of the program to be debugged.

14. The system according to claim 9 wherein the instrumenting means is configured to add a debug agent to the virtual machine.

15. The system according to claim 9 wherein the instrumenting means is configured to realize instrumenting the debug logic code before the code lines of the program to be debugged by a rewriting class loader.

16. The system according to claim 9 wherein the instrumenting means is configured to realize instrumenting the debug logic code before the code lines of the program to be debugged by class-transforming the program to be debugged through a compiler.

17. The system according to claim 9 wherein the request for debugging the program includes a request for debugging a part of classes in the program, and wherein the code lines of the program to be debugged include code lines of a part of classes to be debugged.

18. The system according to claim 9 wherein the virtual machine is not restarted during debugging.

19. The system according to claim 9 wherein the virtual machine is a process virtual machine.

20. The system according to claim 9, wherein the instrumenting means is configured to instrument the debug logic code before the code lines to be debugged of the program.

21. An article of manufacture comprising:
a non-transient computer readable medium storing instructions, which when executed by a processor cause the processor to perform processes on a virtual machine, the processes comprising:
receiving a request for debugging a program;
instrumenting debug logic code into code to be debugged of the program; and
running the program code with the instrumented debug logic codeinstrument to debug the program,
wherein, instrumenting the debug logic code for the program to be debugged is realized by adding a debug agent to the virtual machine, and
class-transforming the program to be debugged through the added debug agent or
class-redefining the program to be debugged through the added debug agent or
class-transforming the program to be debugged through a compiler.

22. The article of manufacture of claim 21 wherein the debug logic code includes corresponding operations executed with respect to different debug commands.

23. The article of manufacture of claim 21 wherein running the program code with the debug logic code instrumented to debug the program includes:
running the program code with the debug logic code instrumented, line by line;
receiving the debug command of the program code of the line; and
according to the received debug command, executing the corresponding operation defined by the instrumented debug logic code.

24. The article of manufacture of claim 21 wherein the instructions cause the processor to perform additional processes that comprise:
receiving a request for ending the program debugging; and
removing the debug logic code from said program code.

25. The article of manufacture of claim 21 wherein instrumenting the debug logic code before the code lines of the program to be debugged is realized by rewriting a class loader.

26. The article of manufacture of claim 21 wherein the request for debugging the program includes a request for debugging a part of classes in the program, and wherein the code lines of the program to be debugged include code lines of a part of classes to be debugged.

27. The article of manufacture of claim 21 wherein the virtual machine is a process virtual machine.

28. The article of manufacture of claim 21 wherein instrumenting the debug logic code before the code lines of the program to be debugged includes:
instrumenting the debug logic code before the code lines to be debugged of the program.
